(19) United States
(12) Patent Application Publication
(10) Pub. No.: US 2019/0109789 A1
(43) Pub. Date: Apr. 11, 2019

(54) INFRASTRUCTURE AND COMPONENTS TO PROVIDE A REDUCED LATENCY NETWORK WITH CHECKPOINTS

(71) Applicant: Intel Corporation, Santa Clara, CA (US)

(72) Inventors: Ben-Zion FRIEDMAN, Jerusalem (IL); Eliezer TAMIR, Bait Shemesh (IL); Eliel LOUZOUN, Jerusalem (IL)

(21) Appl. No.: 16/211,385

(22) Filed: Dec. 6, 2018

(51) Int. Cl. H04L 12/741; H04L 29/06; H04L 12/761; H04L 12/863

(52) U.S. Cl. CPC H04L 45/745; H04L 47/50; H04L 45/16; H04L 69/22

(57) ABSTRACT

A lower latency communications path is provided with checkpointing to verify a packet transmission is permitted. When a client initiates communication with the lower latency path, the client uses the unique tag in a packet to be transmitted. The network interface of the transmitter device can verify that the packet is an acceptable format and formed in an accepted manner. If the packet is verified, the network interface can transmit the packet to a next node according to the end-to-end configuration. The next node can read the packet's unique tag and verify the packet is an accepted format using context information associated with the unique tag. Each device in the path can perform a verification based on the tag in the packet before allow progress to a next prescribed step. A destination device can perform a verification based on the tag in the packet before allow progress to the destination receive queue.

### TECHNICAL FIELD

Various examples are described herein that relate to networking and a routing path for packet transmissions.

### BACKGROUND

Data centers provide vast processing, storage, and networking resources to users. For example, smart phones or internet of things (IoT) devices can leverage data centers to perform computation, data storage, or data retrieval. Data centers are typically connected together using high speed networking devices such as network interfaces, switches, or routers. In particular, high performance computing (HPC) systems can require secure and low latency communications capabilities.

### BRIEF DESCRIPTION OF THE DRAWINGS

FIG. 1 depicts an example system.

FIG. 2 depicts an example format of a packet that can be formed for transmission using a faster path.

FIG. 3A depicts an example look-up-table format that can be used by a switch device to determine if a packet is to be routed using a faster path.

FIG. 3B depicts an example look-up-table format that can be used by a destination device to determine if a packet is to be routed to a faster path destination queue.

FIG. 4 depicts an example process that can be used to initialize an end-to-end connection for faster path packet transmissions.

FIG. 5 depicts an example process that can be used by a transmitting system to determine if a packet is to be transmitted using a faster path or normal path.

FIG. 6 depicts an example process that can be used by a switch or routing system to determine if a packet is to be transmitted using a faster path.

FIG. 7 depicts an example process that can be used by a destination system to determine if a packet is to be transferred to a destination queue associated with a faster path.

FIGS. 8A and 8B depict an example of a packet transmission using a faster path.

FIG. 9 depicts an example network interface.

FIG. 10 depicts an example of a computing system.

### DETAILED DESCRIPTION

High performance computing (HPC), such as those that leverage Cray supercomputers and/or Intel® Xeon® processors, are offered for use but acceptable communications networks are not available for use in a cloud environment. Current HPC communications networks were not designed with security as a high priority and can be unsuitable for use in a cloud environment that uses distributed computing resources interconnected using a network. In a virtualized cloud environment, a security concern is that a cloud tenant is not able to access to another tenant's resources. While virtual machines (VMs) provide for securely sharing compute resources, securely sharing an HPC communications network compromises the network's performance. For HPC platforms, networks with security features to interconnect platforms slows down communications between platforms.

Deep tunneling or complex Ethernet header structures can be used to present a tenant with an abstract “flat” network topology that hides the actual data center network topology. A tenant could rent one VM on one kind of hardware and rent another VM on different hardware. However, this solution uses a complex network infrastructure to be able to parse highly complex headers. Moreover, this solution does not allow for fast routing and low end-to-end latency needed by HPC.

Microsoft® Azure provides for two parallel networks: an Ethernet network to provide the capability of tunneled networks and a local InfiniBand network for HPC applications. Pools of servers in the data center are connected to these two networks. When an HPC application is set up, it is provisioned on an island of dedicated servers and configured to use the InfiniBand network. This solution has limitations because of constraints on what ways each pool can be used, which in return limits how close to full utilization a network can achieve, which translates to higher monetary cost. This redundant mesh network scheme is expensive and lacks the flexibility for cloud use cases.

An embodiment provides for a lower latency communications path with a verification feature at the transmitter and verification features at each device in a path to a destination to verify a packet transmission using the lower latency communications path is permitted. Some embodiments can provide secure communications for HPC platforms and other uses. If a packet fails verification at any juncture, the packet can be discarded or the path can be deactivated. A non-lower latency path can also be supported by any transmitter, switch, router, or endpoint destination in the network.

For example, a client can request use of the lower latency path. If use of the lower latency path is permitted, a unique tag can be assigned to the client and an end-to-end device path can be set-up including designated ports and queues. When the client initiates communication using the lower latency path, the client includes the unique tag in a transmit packet. The network interface of the transmitter device can verify that the packet is an acceptable format, has an expected context, and is formed in an accepted manner. If the packet is verified, the network interface can transmit the packet to a next node according to the end-to-end routing configuration. The next node can read the packet's unique tag and verify the packet is an accepted format using context information associated with the unique tag. Each device in the path can perform a verification based on the tag in the packet before allow progress to a next prescribed hop. A destination device can perform a verification based on the tag in the packet before allowing progress to the destination receive queue.

A determination can be made as to whether a packet can use a faster path based on the packet's tag and packet context. If the packet's tag and packet context match characteristics accepted for use by the faster path, then the faster path can be used. If the packet's tag and packet context do not match characteristics accepted for use by the faster path, then a non-faster path can be used.

An embodiment provides a converged network that could support cloud networking capabilities while allowing the data center management to provision any network or compute asset to create a local low latency network. This low latency network is able to isolate network traffic from cloud tenants from each other. A security scheme provides one or more of the following: preventing low latency traffic from starving the regular datacenter traffic and vice versa; preventing a malicious node from using or adversely affecting the network; isolating the faster path network from the regular logical network; or isolating different tenants' traffic and potentially presenting each with a “flat” virtual topology.

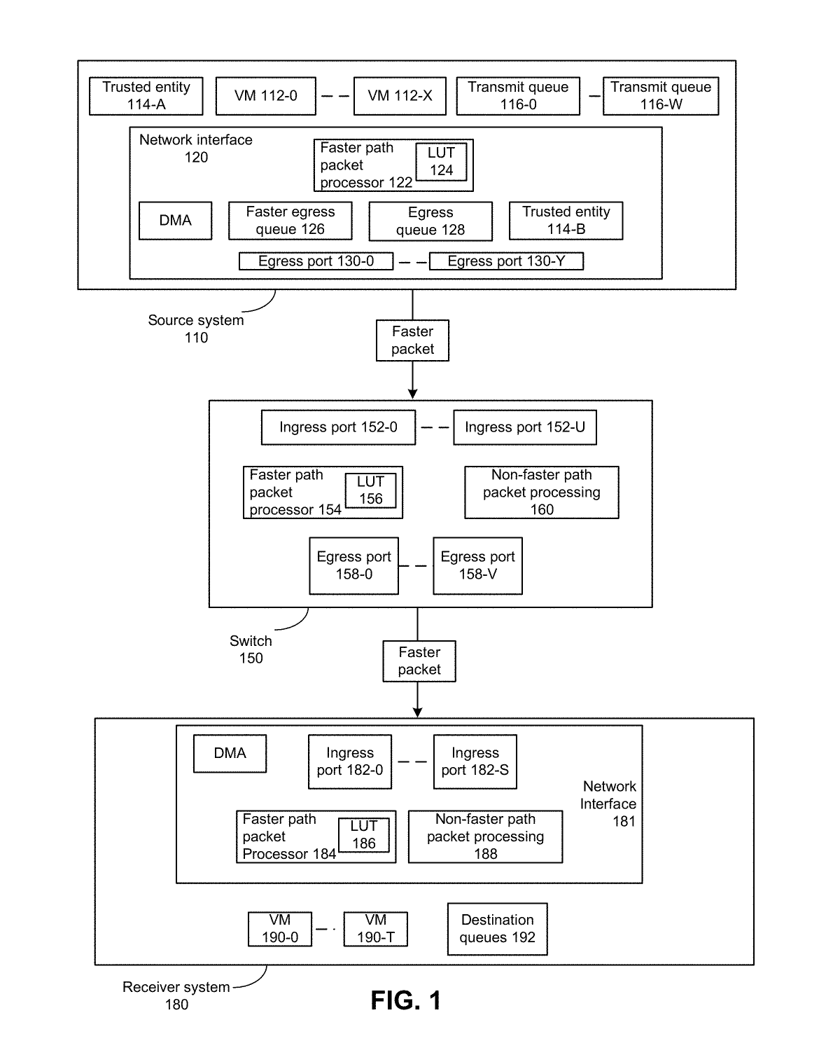

FIG. 1 depicts an example system. In this example, the system can include a source system 110, switch 150, and destination receiver system 180. Other configurations can be used such as the use of multiple switches to route traffic between source system 110 and destination receiver system 180. Source system 110 can include a host system with processor, memory, and storage resources, and a network interface. Source system 110 can be capable of initializing at least one faster path for transmitted packets by use of a distinct routing and/or queue tag as well as using a conventional path for transmitted packets. All devices in the transmission path validate that the transmitted packet can use the faster path for transmission. Source system 110 can also provide for other types of packet transmission or routing.

In this example, a requester (e.g., one or more of virtual machines VM 112-0 to VM 112-X) executed on source system 110 can request a transmission of a packet using a faster path communication channel to receiver system 180. A requester can be an application, any software, a node, or any networked device. In other examples, any other software (e.g., container, application, operating system, and so forth) can initiate a faster path packet transmission. To gain permission to transmit a packet using a faster path, the virtual machine can request a trusted entity 114-A or trusted entity 114-B, or both to initiate a faster path communication. In some cases, a faster path can provide the same or slower throughput or transmission rate (or the same or higher end-to-end time) as that of a non-faster path.

Trusted entity 114-A can be executed by a host system whereas trusted entity 114-B can be executed by network interface 120 communicatively coupled to the host system. Trusted entity 114-AB can set up an end-to-end connection of faster transmit queue and receive queue configurations from the transmitter, switch 150, and to destination receiver 180. Trusted entity 114-AB can determine or assign a faster path routing tag and queue tag for the request, a packet structure for the request, an expected header value for the request (e.g., MAC source and destination address, IP source and destination address, VLAN etc.), and a packet structure. Trusted entity 114-AB can store the faster path packet context in look-up-table 124. Trusted entity 114-AB can share the faster path routing tag, queue tag, and packet structure with the requester of the faster path transmission. Trusted entity 114-AB in coordination with an orchestrator can set a path through switch 150 to receiver 180. Path initialization can include setting ingress ports, egress ports, transmit queues, receive queues, and a destination queue in look-up-tables of source system 110, switch 150, and receiver system 180.

For VMs running on a shared device, trusted entity 114-A can be executed on a host device and can be implemented as a virtual machine manager (VMM), packet filter, firewall, orchestrator, or other implementations. For example, a virtual switch (e.g., Open vSwitch) control flow can be modified to be used to initiate and manage a faster path connection. In bare metal server cases where, for example, a single customer uses computing resources of a server and those resources are not shared among other customers (unless the single customer chooses to), trusted entity 114-B can be implemented on the network interface. Examples of the trusted entity 114-B include portions of embedded network interface firmware, baseboard management controller (BMC), and so forth.

A requester that requested a faster path transmission can form a transmit packet that includes the routing tag and queue tag in a MAC layer header and uses a packet structure provided by trusted entity 114-AB. The requester can place the packet (or reference the packet) in a transmit queue 116-0 to 116-W prescribed by trusted entity 114-AB for use to use the faster path. Network interface 120 can validate the transmit packet is permitted to be transmitted using faster path packet processor 122. For example, faster path packet processor 122 can determine if the requester is permitted to transmit a packet using the faster path by reviewing the transmit packet's routing tag and queue tag as well as transmit queue number, source MAC address, and transmit packet structure by comparison against valid entries in look-up-table 124.

If faster path packet processor 122 validates the transmit packet for use by the faster path, the transmit packet can be transferred to faster path egress queue 126. If the transmit packet is not validated for transmission, then the packet can be discarded and the faster path routing is terminated. Network interface 120 can be used to transmit packets using non-fast path via egress queue 128. An assigned egress port of egress ports 130-0 to 130-Y can be used to transmit a packet using a faster path to switch 150.

Switch 150 can include ingress ports 152-0 to 152-U that can receive a faster or non-faster path packets from source system 110. In an example, a faster path traffic is set to be received at ingress port 152-0 and the transmit packet from system 110 is received at ingress port 152-0. Faster path packet processor 154 can determine if the transmit packet is permitted to use the faster path. For example, faster path packet processor 154 can retrieve a routing tag from the transmit packet and use the routing tag to retrieve packet context information from LUT 156 to determine if the transmit packet includes expected characteristics to use the particular faster channel. If the transmit packet can use the transmit packet, then routing information from LUT 156 can be used to assign an egress port among ports 158-0 to 158-V and an egress queue (not shown). In an example, egress port 158-0 is assigned to the transmit packet and an egress queue 0 (not shown) associated with egress port 158-0 is to be used to transport the transmit packet to receiver 180.

If the transmit packet fails validation, it can be discarded, the faster path terminated, or the packet is routed to a packet queue for storage but not forwarded to receiver 180. Switch 150 can provide for packet processing and routing of packets that do not use the faster path.

Note that LUT 156 can use a routing tag that is 8 or 16 bits in length to associate with faster path packet context information. By contrast, using a MAC address for look-up of context uses 6 octets (48 bits) resulting in a look-up-table that is much larger than LUT 156.

Receiver system 180 can include a host system that provides computing, memory, and storage resources and a network interface 181. Ingress ports 182-0 to 182-S can receive packets allocated for a faster path transmission. Faster path packet processor 184 can determine if the received packet is permitted to use the faster path. For example, faster path packet processor 184 can retrieve a queue tag from the received packet and use the queue tag from the received packet to retrieve information from LUT 186 to determine if the packet includes expected characteristics to use the faster path. If the received packet can use the faster path, then routing information from LUT 156 can be used to assign a destination queue among destination queues 192. If the transmit packet fails validation, it can be discarded or routed to a packet queue.

Non-faster path packet processing 188 can provide for packet processing and routing of packets that do not use the faster path. For example, non-faster path packet processing 188 can cause the packet to be routed to a destination queue 192 or transmit the packet to another device. For example, a virtual machine 190-0 to 190-T (or other software or hardware) can access contents of the received packet.

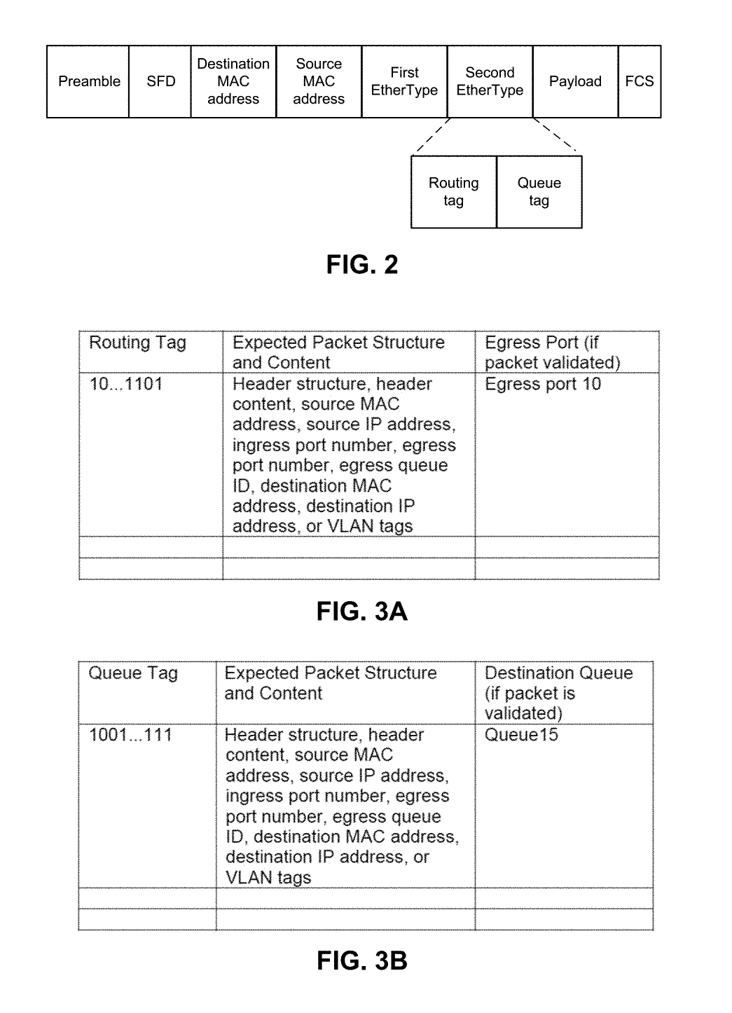

FIG. 2 depicts an example format of a packet that can be formed for transmission using a faster path. For example, a packet can be an Ethernet frame according to IEEE 802.3. In this example Ethernet frame, a first EtherType field can indicate that a second EtherType field includes a routing tag or a queue tag (or both) that are used for verification that faster path routing can be used for a packet. The routing tag can be used by one or more switch or router in a path from a source to a destination. The routing tag can be used to identify a context for a packet that is used to verify the packet can be routed using the faster path. For example, the routing tag can be 16 bits. The queue tag can be used by a destination receiver to determine if a received packet is properly transmitted using the faster path and to determine a receive queue to place the received packet. For example, the queue tag can be 16 bits.

Other example locations of the routing tag and/or queue tag in an Ethernet packet may be after a Source MAC address, in a Virtual Bridged Local Area Network (VLAN) tag, and so forth.

FIG. 3A depicts an example look-up-table format that can be used by a switch device to determine if a packet is to be routed using a faster path. A routing tag can be identified in a received packet and used to retrieve context from a look-up-table. The retrieved context can include one or more of: header structure, header content, source MAC address, source IP address, ingress port number, egress port number, egress queue ID, destination MAC address, destination IP address, or VLAN tag(s). If the received packet exhibits one or all of the characteristics that are specified in the look-up-table, the packet is considered to be accepted to use the faster path and can be routed to a next device using the egress port entry.

FIG. 3B depicts an example look-up-table format that can be used by a destination device to determine if a packet is to be routed to a faster path destination queue. A queue tag can be identified in a received packet and used to retrieve context from a look-up-table. The retrieved context can include one or more of: header structure, header content, source MAC address, source IP address, ingress port number, egress port number, egress queue ID, destination MAC address, destination IP address, or VLAN tag(s). If the received packet exhibits one or more characteristics that are specified in the look-up-table, the packet is considered to be legitimate and can be routed to a destination queue specified in the table.

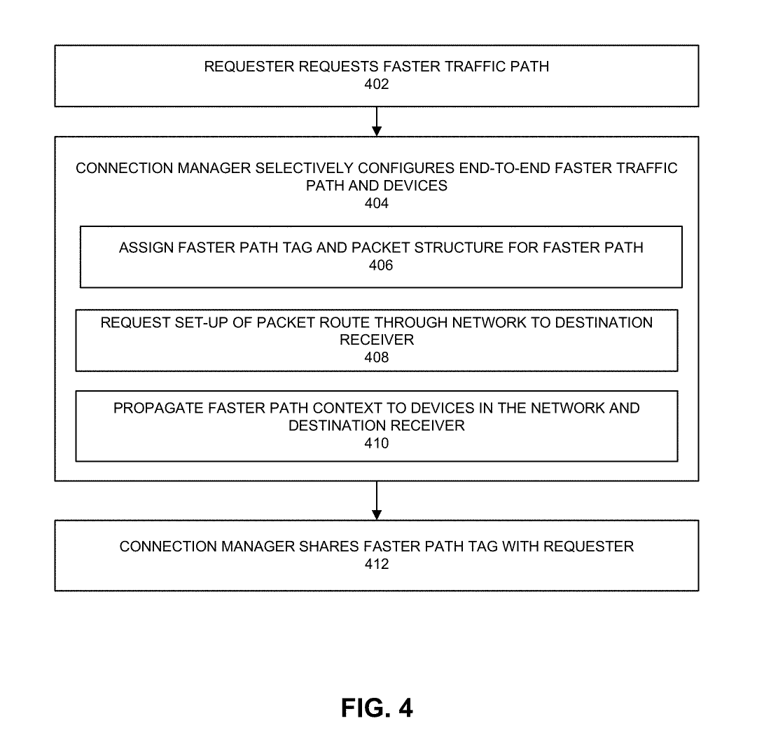

FIG. 4 depicts an example process that can be used to initialize an end-to-end connection for faster path packet transmissions. An example of faster path traffic includes traffic that an application or other software or hardware deems as time sensitive and requests use of a lower latency transport. For example, faster path traffic can be generated by an HPC platform, high frequency trading information, controls for self-driving vehicles, data for augmented or visual reality, or other examples. The faster path connection can be even higher speed than offered from the highest quality of service (QoS) traffic.

At 402, a requester requests a connection manager for the establishment of a faster path connection. The requester can be, for example, a virtual machine (VM), container, HPC on tenant, application, or other software or hardware. The connection manager can be a trusted entity on a host or network interface and an orchestrator. This request can include the source IP address, destination IP address, and expected packet format (e.g., maximum packet payload size). The requester may not have the ability to establish a faster path connection and instead, the connection manager forms the faster path connection. A trusted entity can reject a request to create a faster path for a variety of reasons. For example, the requester may have exceeded a number of faster path allocations, the requester is not suitable for using faster path, or a receiver VM is not suitable for using faster path communication.

At 404, if the connection manager approves the creation of a faster path connection, the connection manager sets up an end-to-end connection of faster transmit and receive queue configurations from the transmitter, through the network, and to the destination receiver. In some examples, action 404 can include one or more of: actions 406, 408, and 410.

For example, at 406, the connection manager can determine or assign a faster path routing and queue tag for the request and future transmissions using the faster path, a packet structure for the request, expected header values for the request (e.g., MAC source and destination addresses, IP source and destination addresses, VLAN tags, and so forth).

For example, at 408, the connection manager in coordination with an orchestrator can set a switch path through switching and routing devices (including ingress ports, egress ports, transmit queues, and receive queues in each device through the switch path), and also sets the destination queue at the endpoint destination. The connection manager can set the faster path through the network by coordinating with a network orchestrator that controls network traffic routing.

For example, at 410, the connection manager coordinates with the network orchestrator to inform the in-path switches or routers, and the destination receiver of the new tags and the routing decisions to be made based on the faster path tag. Connection manager coordinates with the network orchestrator to inform the switches, routers, and receiver of the faster path of faster context information including one or more of: routing and queue tag, packet structure, expected header value (MAC source and destination addresses, IP source and destination addresses, VLAN tags, and so forth) as part of the queue context. Subsequently, a look-up operation can be performed to verify context information for each packet based on its faster path tag (e.g., routing and/or queue tag). If the context information is verified, the packet is considered permitted to use the faster path.

At 412, the connection manager shares the faster path tag, transmission queue, and faster packet structure with the requester. Subsequently, the requester can use the faster path tag and specified transmission queue to transmit one or more packets using a faster path by forming a packet and including the routing and queue tag in each packet header. In an example, the faster path tag and faster path connection can be valid for a period of time and closed for packet transmission requests after the time expires. In another example, the faster path tags and connection are open until an unverified use is detected or the requester, trusted entity, or orchestrator closes the connection.

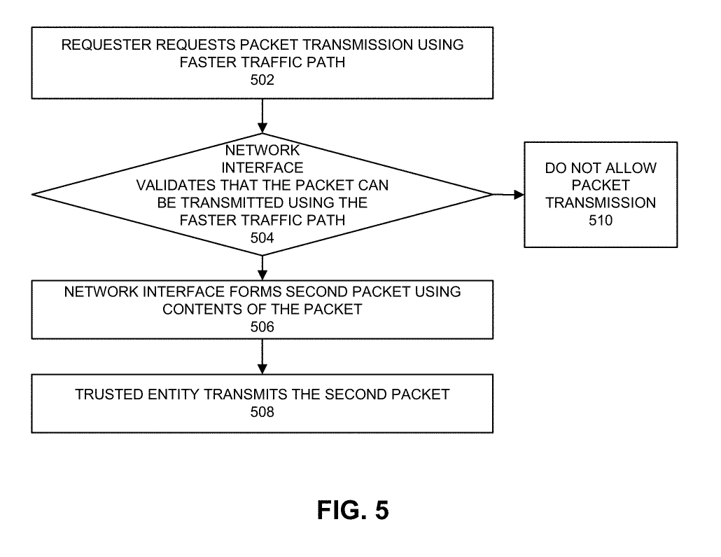

FIG. 5 depicts an example process that can be used by a transmitting system to determine if a packet is to be transmitted using a faster path or normal path. At 502, a requester requests a packet transmission using a faster traffic path. For example, a VM forms a transmit packet in a packet queue for transmission that includes a routing tag in its layer 2 header (e.g., MAC layer). The VM can feed eager traffic to the network interface device as “push” traffic whereby the VM writes the faster path packet to an egress queue without use of a DMA operation.

At 504, a network interface determines if the packet can be transmitted using the faster traffic path. For example, the network interface can validate a transmit packet formed for faster path transmission by reviewing the transmit packet's routing and queue tag and transmit queue context. The network interface can determine if the source information (e.g., MAC and IP addresses and transmission queue) is as provisioned. For example, the network interface checks the transmit packet is well structured, the transmitter queue is accepted, and the addresses are valid, and other header parameters (e.g., VLAN tag). The network interface performs source anti-spoofing to determine if the transmitter entity is permitted to transmit a packet using the faster path.

If there is a determination that the packet can be transmitted using the faster traffic path, then at 506, the network interface can form a second packet that encapsulates the transmit packet but uses the routing and queue tags of the transmit packet in the header of the second packet. The formed packet can be placed in a faster path transmit queue or reference to the formed packet can be placed in a faster path transmit queue. When connected to a mixed network (legacy and faster path capable switches), the network interface can provide the transmission packet for transmission with the routing and queue tags to the outer L2 header. At 508, the network interface transmits the second packet. In another example, at 506 and 508, the network interface can forward and transmit the transmit packet instead of encapsulating the transmit packet in a second packet and transmitting the second packet.

Based on a determination that the packet cannot be transmitted using the faster traffic path, at 510, the transmit packet is not permitted to be transmitted. If the TX packet is not permitted as a faster path transmission, the trusted entity in the host is notified and/or the orchestrator is notified. The packet can be dropped and the TX queue may be closed at the source. The trusted entity could close the faster path or shut down the requester. In some cases, the transmit packet can be transmitted using the non-faster path.

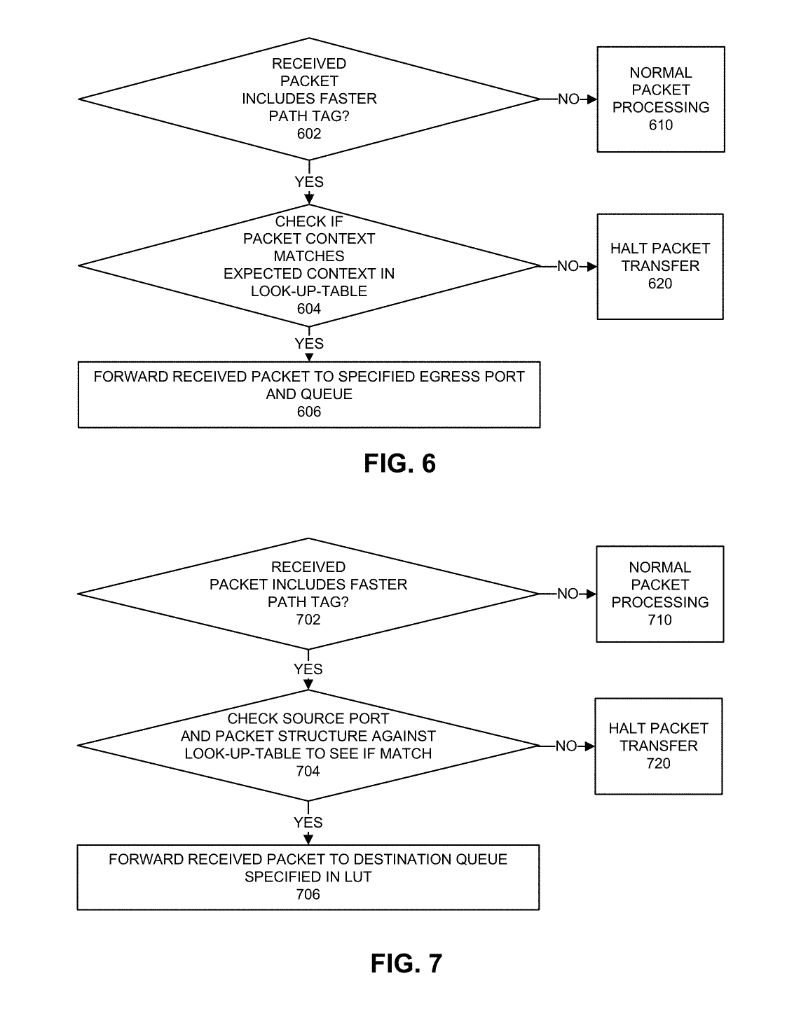

FIG. 6 depicts an example process that can be used by a switch or routing system to determine if a packet is to be transmitted using a faster path. At 602, a determination is made as to whether a received packet includes an accepted faster path tag. For example, a switch or routing system can check for the presence of a routing tag in every received packet as part of a packet processing flow. If the packet includes a routing tag, then the packet is processed using faster path packet processing and 604 follows. If the packet does not include a routing tag or a faster path indicator, the packet is processed at 610.

At 610, packets that do not include the faster path tag are parsed and switched using routing and forwarding table lookup. Standard IP and Ethernet switching and routing can be applied. Datacenter defined tunneling can be applied.

At 604, the network interface checks that the packet is permitted to use the faster path. The network interface can retrieve a connection context from a look-up-table based on a routing tag in the packet. The look-up-table includes a connection context for each routing tag and the connection context includes one or more of: transmit queue identifier, header structure, header content, source MAC address, source IP address, ingress port number, egress port number, egress queue ID, destination MAC address, destination IP address, or VLAN tag. The look-up-table can include pre-computed information. Action 604 can include verification that the source port (that sent the packet) is indicated in the look-up-table is the actual source port through which the packet was transmitted. Switches will not accept fastpath packets from outside the end-to-end route. If the packet has expected context characteristics, then 606 follows. If the packet does not have expected characteristics, then 620 follows.

At 606, the packet is forwarded intact to an egress port and queue. The egress port and queue can be specified in the look-up-table in the context associated with the routing tag. To support a mixed network of legacy and faster path capable switches, the routing tag and other faster path indicators are provided in the layer 2 header in such a way that a legacy switch will properly forward the packet to its destination, keeping the routing tag and other faster path indicators intact.

If the packet check fails at 604, then at 620, the packet transfer is halted. A trusted entity at the source transmitter and/or orchestrator are notified, and the packet can be dropped and the transmit queue that originated the packet at the source transmitter can be closed. This filters out malicious packets sent by an external entity attempting to send a false faster path packet. The packet can be forwarded to a default packet filter (PF) queue. The PF may notify the sender's platform packet filter about the existence of a malicious misconfigured packet transmission. The sender platform packet filter may then take appropriate action to shut down attempts to transmit using the failing queue tag.

In some cases, if a packet check fails, then at 620, a non-faster packet processing can be applied and the packet can be transferred using the non-faster path to another device or a queue.

FIG. 7 depicts an example process that can be used by a destination system to determine if a packet is to be transferred to a destination queue associated with a faster path. In response to receipt of a packet, at 702, a determination is made if the packet includes a faster path queue tag. If the received packet includes the faster path queue tag, then 704 can follow. If the received packet does not include the faster path routing or queue tag, then 710 can follow whereby conventional packet processing such as described with respect to 610 can be used.

At 704, a determination is made as to whether the packet has the proper context. A context entry associated with the queue tag is retrieved from a look-up-table. A comparison of the packet and its context can be made against one or more of: header structure, header content, source MAC address, source IP address, ingress port number, egress port number, egress queue ID, destination MAC address, destination IP address, or VLAN tag. If there is a match between packet characteristics and context and those retrieved from the look-up-table, then 706 can follow. However, if there is a mismatch between packet characteristics and context and those retrieved from the look-up-table, then 720 can follow.

At 706, the network interface forwards the packet to the destination receive queue. The destination receive queue can be specified in the look-up-table entry associated with the queue tag in the received packet. Thereafter, software or hardware at the receiver can access the received packet.

At 720, verification of the packet fails and the packet progress is halted. Action 720 can similar or include some or all of the activities of action 620.

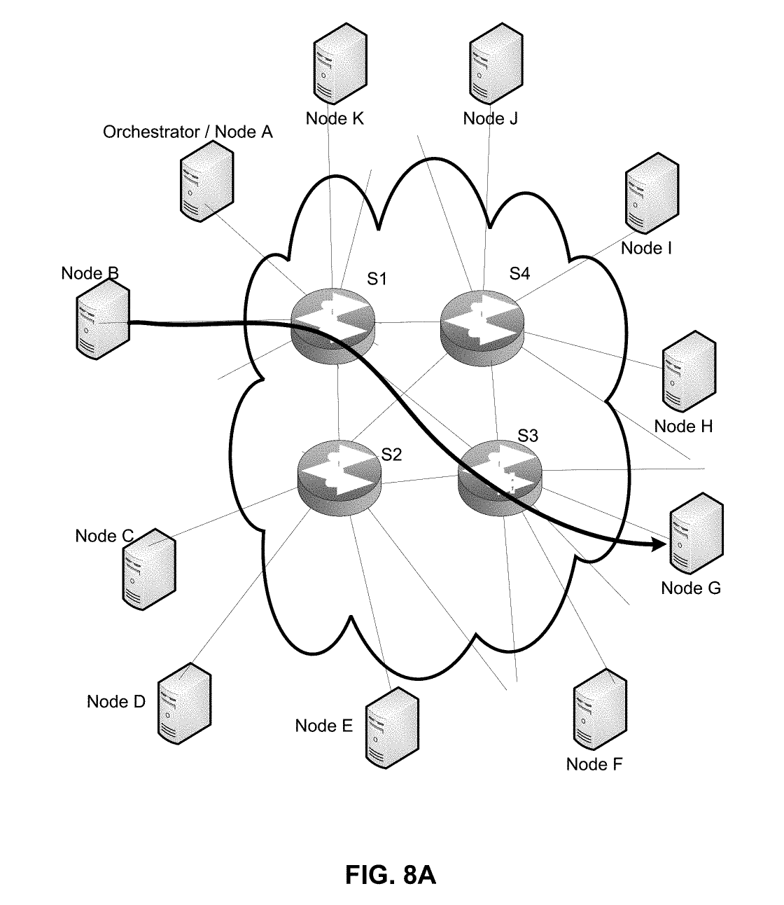

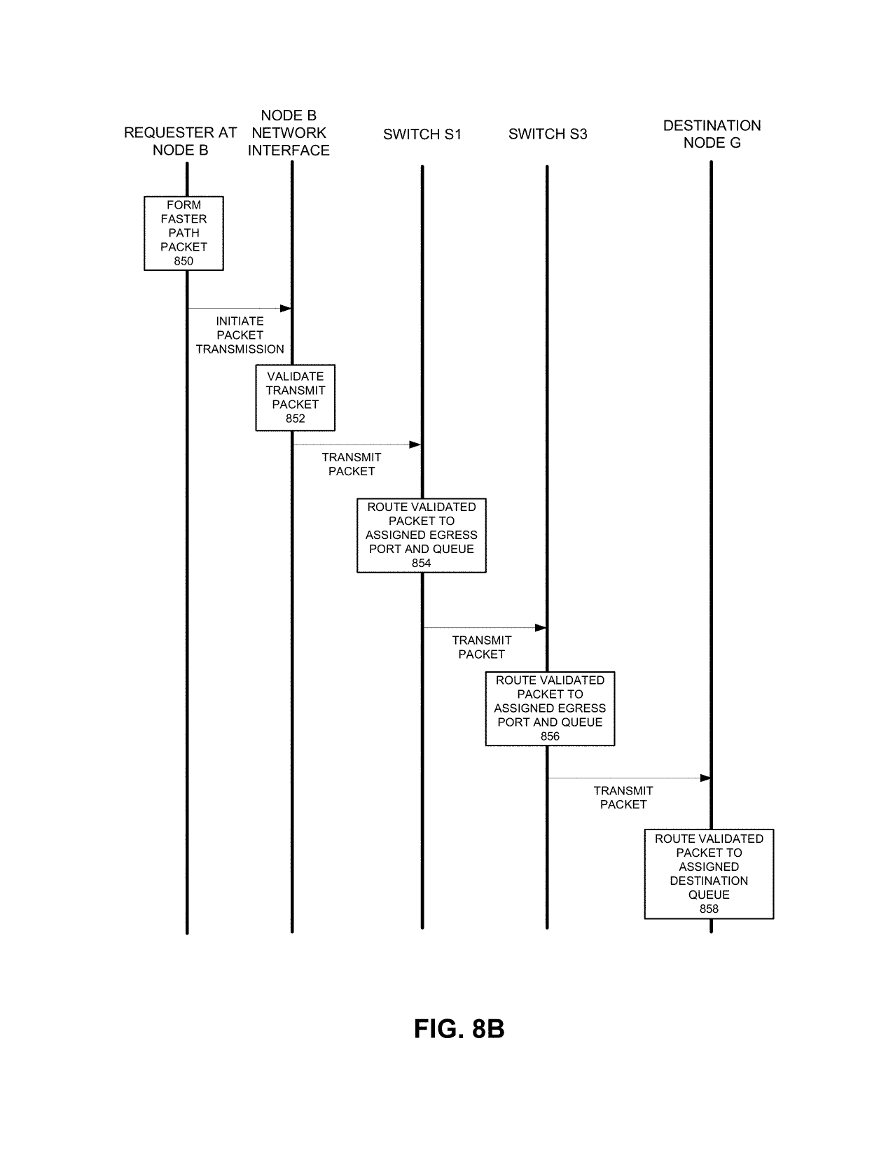

FIG. 8A depicts an example of a packet transmission using a faster path. A Node B transmits a packet through switches S1 and S3 to Node G. The trusted entity can determine a packet and/or header format for a packet to use the faster path. A trusted entity at Node B and an orchestrator executed by Node A can configure a faster path for packets from Node B, through Switches S1 and S3, to Node G by setting port and queue path and sharing faster path traffic tags and context with path members. Each of Node B, Switches S1 and S3, and Node G can be configured with a look-up-table to determine context information for a packet that the packet is to satisfy if the packet is to proceed to a next step in the faster path.

FIG. 8B depicts an example of communications using a packet transmission using a faster path corresponding to the example of FIG. 8A. In this example, the packet is a valid faster path packet and it is validated for transmission and routing to a destination queue. If the packet is not a valid packet, it would not be permitted to use the faster path and could be dropped by any of Node B, Switch S1, Switch S3, or destination Node G. In this example, at 850, a requester at node B requests to transmit a packet using a faster path. For example, the requester can be a virtual machine at an HPC platform that generates a packet for transmission to another HPC platform. The transmit packet includes routing and/or queue tags assigned for faster path traffic. The requester copies the packet or reference to the packet into a network interface transmit queue. At 852, the Node B network interface compares the source queue, packet structure, routing and queue tags, and source and destination addresses against an accepted format to verify the packet is allowed in the faster path transmit queue. If validated, the Node B network interface transmits the packet to node G via switch S1.

Switch S1 receives the packet from node B. At 854, Switch S1 attempts to validate the received packet and route the validated packet to the associated egress port and transmit queue. Switch S1 inspects the routing tag of the received packet and retrieves an entry in a look-up-table that provides context of the packet. For example, a context of a packet can include one or more of: node B egress port, Switch S1 ingress port, packet format, or header format. Instead of using a VLAN, destination MAC address or other information, the routing tag is used to route the packet. If the context of the received packet matches that stored in the look-up-table, then Switch S1 forwards the packet to an egress port and associated queue as specified in the look-up-table. If the destination port is free, the packet can be forwarded by cut-through switching whereby the switch starts forwarding a packet as soon as the destination address is processed and potentially before the whole packet has been received. Switch S1 transmits the packet to switch S3.

Switch S3 receives the packet from Switch S1. At 856, Switch S3 performs similar operations as performed in 854. If the context of the received packet matches that stored in the look-up-table, then Switch S3 forwards the packet to an egress port and associated queue as specified in the look-up-table. If the destination port is free, the packet can be forward using cut-through switching. Switch S3 transmits the packet to destination node G.

Destination Node G receives the packet and performs processing to determine if the packet has queue tag. At 858, destination Node G attempts to validate that the packet is permitted to use the faster path and permits transfer of a validated packet to a destination queue. Destination Node G retrieves a context from a look-up-table based on the queue tag in the packet. Destination Node G compares a packet or header structure to the expected packet or header structure and other context specified in the look-up-table. If the packet is validated, it is forwarded to the destination receive queue specified in the look-up-table.

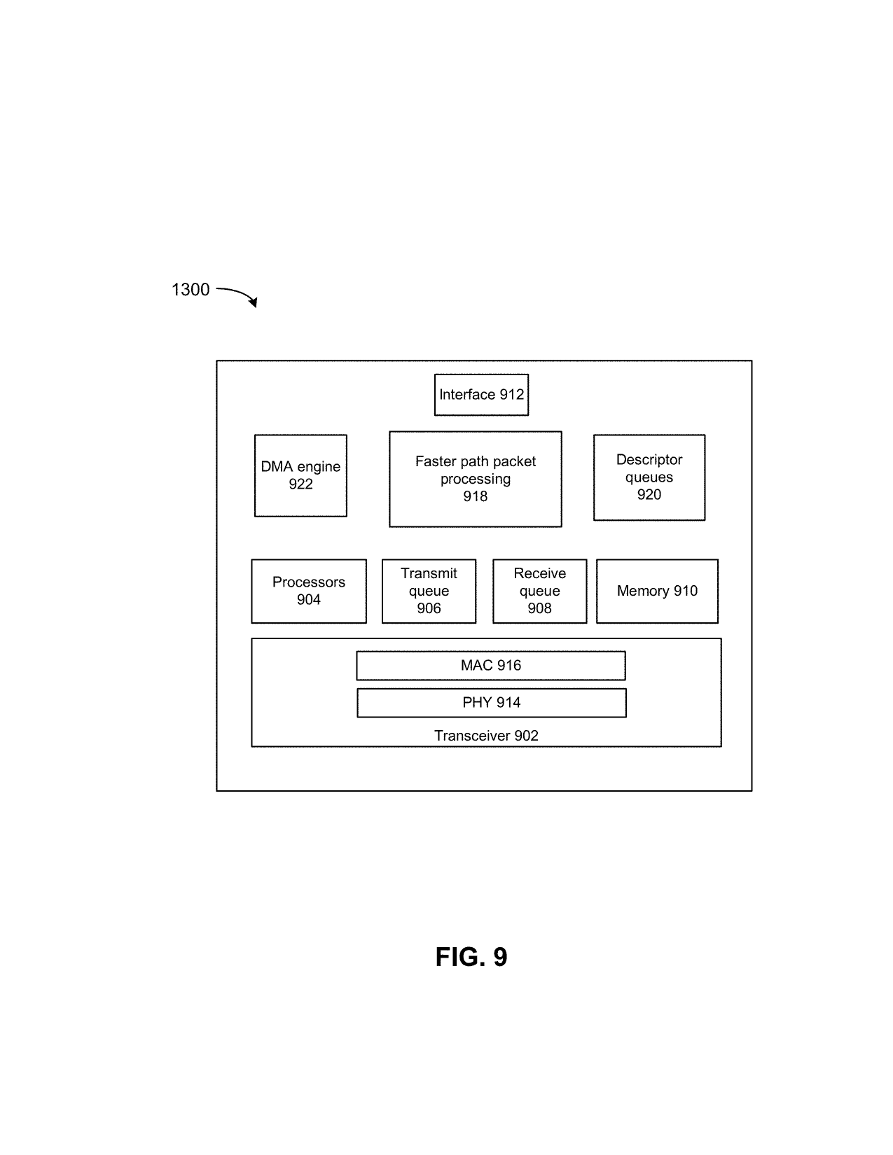

FIG. 9 depicts an example network interface. Network interface 900 can include transceiver 902, processors 904, transmit queue 906, receive queue 908, memory 910, and bus interface 912, faster path packet processing 918, descriptor queues 920, and DMA engine 922.

Transceiver 902 can be capable of receiving and transmitting packets in conformance with the applicable protocols such as Ethernet, FibreChannel, Infiniband, Omni-Path, although other protocols may be used. Transceiver 902 can receive and transmit packets from and to a network via a network medium (not depicted). Transceiver 902 can include PHY circuitry 914 and media access control (MAC) circuitry 916. PHY circuitry 914 can include encoding and decoding circuitry (not shown) to encode and decode data packets. MAC circuitry 916 can be configured to assemble data to be transmitted into packets, that include destination and source addresses along with network control information and error detection hash values. Processors 904 can be any processor, core, graphics processing unit (GPU), or other programmable hardware device that allow programming of network interface 900. For example, processors 904 can execute faster path packet processing system 918 that can validate whether a packet is to use a faster path based on properties of the packet. Memory 910 can be any type of volatile or non-volatile memory device and can store any queue or instructions used to program network interface 900 as well as a look-up-table indicating a context for a packet permitted to be transmitted using a faster path. Transmit queue 906 can include data or references to data for transmission by network interface. Receive queue 908 can include data or references to data that was received by network interface from a network. Descriptor queues 920 can include descriptors that reference data or packets in transmit queue 906 or receive queue 908. Bus interface 912 can provide an interface with host device (not depicted). For example, bus interface 912 can be compatible with PCI, PCI Express, PCI-x, Serial ATA, and/or USB compatible interface (although other interconnection standards may be used). Direct memory access (DMA) engine 922 can copy a packet header, packet payload, and/or descriptor directly from host memory to the network interface or vice versa, instead of copying the packet to an intermediate buffer at the host and then using another copy operation from the intermediate buffer to the destination buffer.

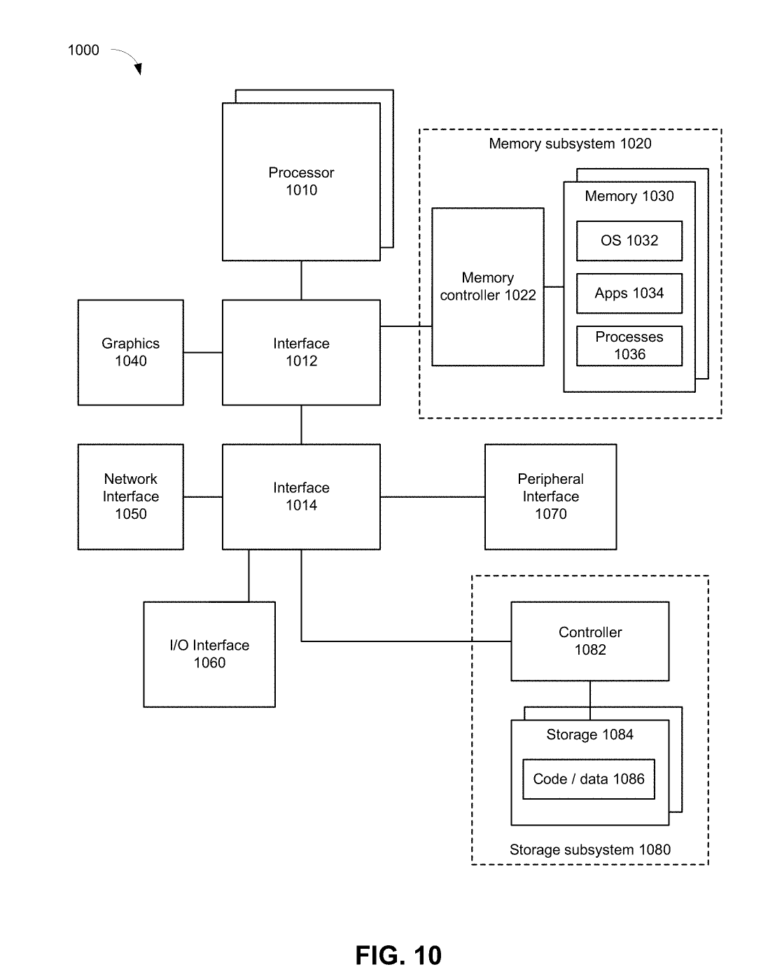

FIG. 10 depicts an example of a computing system. System 1000 represents a computing device in accordance with any example herein, and can be a laptop computer, a desktop computer, a tablet computer, a server, group of servers, a gaming or entertainment control system, a scanner, copier, printer, routing or switching device, embedded computing device, a smartphone, a wearable device, an internet-of-things device or other electronic device.

### [Compute Sled]

System 1000 includes processor 1010, which provides processing, operation management, and execution of instructions for system 1000. Processor 1010 can include any type of microprocessor, central processing unit (CPU), graphics processing unit (GPU), processing core, or other processing hardware to provide processing for system 1000, or a combination of processors. Processor 1010 controls the overall operation of system 1000, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 1000 includes interface 1012 coupled to processor 1010, which can represent a higher speed interface or a high throughput interface for system components that needs higher bandwidth connections, such as memory subsystem 1020 or graphics interface components 1040. Interface 1012 represents an interface circuit, which can be a standalone component or integrated onto a processor die. Where present, graphics interface 1040 interfaces to graphics components for providing a visual display to a user of system 1000. In one example, graphics interface 1040 can drive a high definition (HD) display that provides an output to a user. High definition can refer to a display having a pixel density of approximately 100 PPI (pixels per inch) or greater and can include formats such as full HD (e.g., 1080p), retina displays, 4K (ultra-high definition or UHD), or others. In one example, the display can include a touchscreen display. In one example, graphics interface 1040 generates a display based on data stored in memory 1030 or based on operations executed by processor 1010 or both. In one example, graphics interface 1040 generates a display based on data stored in memory 1030 or based on operations executed by processor 1010 or both.

Memory subsystem 1020 represents the main memory of system 1000 and provides storage for code to be executed by processor 1010, or data values to be used in executing a routine. Memory subsystem 1020 can include one or more memory devices 1030 such as read-only memory (ROM), flash memory, one or more varieties of random access memory (RAM) such as DRAM, or other memory devices, or a combination of such devices. Memory 1030 stores and hosts, among other things, operating system (OS) 1032 to provide a software platform for execution of instructions in system 1000. Additionally, applications 1034 can execute on the software platform of OS 1032 from memory 1030. Applications 1034 represent programs that have their own operational logic to perform execution of one or more functions. Processes 1036 represent agents or routines that provide auxiliary functions to OS 1032 or one or more applications 1034 or a combination. OS 1032, applications 1034, and processes 1036 provide software logic to provide functions for system 1000. In one example, memory subsystem 1020 includes memory controller 1022, which is a memory controller to generate and issue commands to memory 1030. It will be understood that memory controller 1022 could be a physical part of processor 1010 or a physical part of interface 1012. For example, memory controller 1022 can be an integrated memory controller, integrated onto a circuit with processor 1010.

While not specifically illustrated, it will be understood that system 1000 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 13104 bus.

In one example, system 1000 includes interface 1014, which can be coupled to interface 1012. In one example, interface 1014 represents an interface circuit, which can include standalone components and integrated circuitry. In one example, multiple user interface components or peripheral components, or both, couple to interface 1014. Network interface 1050 provides system 1000 the ability to communicate with remote devices (e.g., servers or other computing devices) over one or more networks. Network interface 1050 can include an Ethernet adapter, wireless interconnection components, cellular network interconnection components, USB (universal serial bus), or other wired or wireless standards-based or proprietary interfaces. Network interface 1050 can transmit data to a remote device, which can include sending data stored in memory. Network interface 1050 can receive data from a remote device, which can include storing received data into memory.

In one example, system 1000 includes one or more input/output (I/O) interface(s) 1060. I/O interface 1060 can include one or more interface components through which a user interacts with system 1000 (e.g., audio, alphanumeric, tactile/touch, or other interfacing). Peripheral interface 1070 can include any hardware interface not specifically mentioned above. Peripherals refer generally to devices that connect dependently to system 1000. A dependent connection is one where system 1000 provides the software platform or hardware platform or both on which operation executes, and with which a user interacts.

In one example, system 1000 includes storage subsystem 1080 to store data in a nonvolatile manner. In one example, in certain system implementations, at least certain components of storage 1080 can overlap with components of memory subsystem 1020. Storage subsystem 1080 includes storage device(s) 1084, which can be or include any conventional medium for storing large amounts of data in a nonvolatile manner, such as one or more magnetic, solid state, or optical based disks, or a combination. Storage 1084 holds code or instructions and data 1086 in a persistent state (i.e., the value is retained despite interruption of power to system 1000). Storage 1084 can be generically considered to be a “memory,” although memory 1030 is typically the executing or operating memory to provide instructions to processor 1010. Whereas storage 1084 is nonvolatile, memory 1030 can include volatile memory (i.e., the value or state of the data is indeterminate if power is interrupted to system 1000). In one example, storage subsystem 1080 includes controller 1082 to interface with storage 1084. In one example controller 1082 is a physical part of interface 1014 or processor 1010 or can include circuits or logic in both processor 1010 and interface 1014.

A power source (not depicted) provides power to the components of system 1000. More specifically, power source typically interfaces to one or multiple power supplies in system 1000 to provide power to the components of system 1000. In one example, the power supply includes an AC to DC (alternating current to direct current) adapter to plug into a wall outlet. Such AC power can be renewable energy (e.g., solar power) power source. In one example, power source includes a DC power source, such as an external AC to DC converter. In one example, power source or power supply includes wireless charging hardware to charge via proximity to a charging field. In one example, power source can include an internal battery, alternating current supply, motion-based power supply, solar power supply, or fuel cell source.

In an example, system 1000 can be implemented using interconnected compute sleds of processors, memories, storages, network interfaces, and other components. High speed interconnects can be used such as PCIe, Ethernet, or optical interconnects (or a combination thereof).

Examples described herein can be applied to wired or wireless communication transmitters or transceivers. Examples can be used by or in connection with radio frequency (RF) transceiver components for accessing wireless voice and/or data networks (e.g., using cellular telephone technology, data network technology such as 3G, 4G/LTE, 5G, Wi Fi, other IEEE 802.11 family standards, or other mobile communication technologies, or any combination thereof), components for short range wireless communication (e.g., using Bluetooth and/or Bluetooth LE standards, NFC, etc.), and/or other components.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. It is noted that hardware, firmware and/or software elements may be collectively or individually referred to herein as “module” or “logic.”

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of steps may also be performed according to alternative embodiments. Furthermore, additional steps may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.′”

What is claimed is:

1. A system comprising:
at least one memory and
at least one processor communicatively coupled to the at least one memory,
wherein the at least one processor is to:
determine if a packet, provided for transmission, includes a faster path tag,
verify that the packet has an expected context in response to the packet including the faster path tag, and
in response to verification of the packet, permit the packet to progress.

2. The system of claim 1, wherein the at least one processor is to:
determine if the faster path tag comprises a routing tag that matches a permitted routing tag and
verify that the packet has an expected context that matches an expected context associated with the permitted routing tag.

3. The system of claim 2, wherein the expected context comprises one or more of: transmit queue identifier, header structure, header content, source MAC address, source IP address, ingress port number, egress port number, egress queue ID, destination MAC address, destination IP address, or VLAN tag.

4. The system of claim 2, wherein to permit the packet to progress, the at least one processor is to associate the packet with an egress queue.

5. The system of claim 1, wherein the at least one processor is to:
determine if the faster path tag comprises a queue tag that matches a permitted queue tag and
verify that the packet has an expected context that matches an expected context associated with the permitted queue tag.

6. The system of claim 5, wherein the expected context comprises one or more of: transmit queue identifier, header structure, header content, source MAC address, source IP address, ingress port number, egress port number, egress queue ID, destination MAC address, destination IP address, or VLAN tag.

7. The system of claim 5, wherein to permit the packet to progress, the at least one processor is to associate the packet with a destination queue.

8. The system of claim 1, wherein the at least one processor is to:
perform non-faster path packet processing in response to the packet not including a faster path tag.

9. The system of claim 1, wherein the at least one processor is to:
in response to failed verification of the packet, perform one or more of: discard the packet or initiate closing of a faster transmit path associated with the packet.

10. At least one computer-readable medium comprising instructions stored thereon, that if executed by at least one processor, cause the at least one processor to:
verify that a packet is permitted to use a faster path route based at least in part on the packet context and the packet including a faster path tag.

11. The at least one computer-readable medium of claim 10, wherein to verify that a packet is permitted to use a faster path route based at least in part on the packet context and the packet including a faster path tag, the at least one processor is to:
determine if the faster path tag comprises a routing tag that matches a permitted routing tag and
verify that the packet has an expected context associated with the permitted routing tag.

12. The at least one computer-readable medium of claim 11, wherein the expected context comprises one or more of: transmit queue identifier, header structure, header content, source MAC address, source IP address, ingress port number, egress port number, egress queue ID, destination MAC address, destination IP address, or VLAN tag.

13. The at least one computer-readable medium of claim 11, comprising instructions stored thereon, that if executed by at least one processor, cause the at least one processor to:
permit the packet to progress to an egress queue associated with an egress port, the egress queue and egress port associated with the permitted routing tag.

14. The at least one computer-readable medium of claim 10, wherein to verify that a packet is permitted to use a faster path route based at least in part on the packet context and the packet including a faster path tag, the at least one processor is to:
determine if the faster path tag comprises a queue tag that matches a permitted queue tag and
verify that the packet has an expected context associated with the permitted queue tag.

15. The at least one computer-readable medium of claim 14, wherein the expected context comprises one or more of: transmit queue identifier, header structure, header content, source MAC address, source IP address, ingress port number, egress port number, egress queue ID, destination MAC address, destination IP address, or VLAN tag.

16. The at least one computer-readable medium of claim 14, comprising instructions stored thereon, that if executed by at least one processor, cause the at least one processor to:
permit the packet to progress to a destination queue associated with associated with the permitted queue tag.

17. The at least one computer-readable medium of claim 10, comprising instructions stored thereon, that if executed by at least one processor, cause the at least one processor to:
in response to failed verification of the packet, perform one or more of: discard the packet or initiate closing of a faster transmit path associated with the packet.

18. A system comprising:
a host system comprising one or more processors and one or more memory devices and
a network interface communicatively coupled to the host system, the network interface:
verify that a packet has an expected context in response to the packet including a faster path tag, and
in response to verification of the packet, permit the packet to progress.

19. The system of claim 18, wherein the at least one processor is to:
permit the packet to progress to an egress queue based on the packet having an expected context associated with the permitted routing tag and the faster path tag comprising a routing tag that matches a permitted routing tag,
permit the packet to progress to a destination queue based on the packet having an expected context associated with the permitted queue tag and the faster path tag comprising a queue tag that matches a permitted queue tag and wherein:
the expected context comprises one or more of: transmit queue identifier, header structure, header content, source MAC address, source IP address, ingress port number, egress port number, egress queue ID, destination MAC address, destination IP address, or VLAN tag.

20. The system of claim 18, wherein the network interface comprises a wired or wireless network interface and further comprising one or more of:
at least one storage device communicatively coupled to the network interface, or
at least one interconnect communicatively coupled to the network interface.
